(19) United States
(12) Patent Application Publication
(10) Pub. No.: US 2025/0136809 A1
(43) Pub. Date: May 1, 2025

(54) Conductive Thermoplastic Resin Composition and Molded Article Formed Therefrom

(71) Applicant: LOTTE CHEMICAL CORPORATION, Seoul (KR)

(72) Inventors: Ki Hong CHOI, Uiwang-si (KR); Dong Yeop SHIN, Uiwang-si (KR); Ye Seul SHIN, Uiwang-si (KR); Sung Woo YANG, Uiwang-si (KR); Seo Yun LEE, Uiwang-si (KR); Tae Gon KANG, Uiwang-si (KR); Dong In HA, Uiwang-si (KR)

(21) Appl. No.: 18/838,345

(22) PCT Filed: Feb. 1, 2023
(86) PCT No.: PCT/KR2023/001462

§ 371 Date: Aug. 14, 2024

(30) Foreign Application Priority Data
Feb. 16, 2022 (KR) 10-2022-0019909

(51) Int. Cl. C08L 69/00; C08F 259/08; C08F 279/06; C08K 3/04; C08K 3/34; C08K 5/52; C08K 9/06

(52) U.S. Cl. CPC C08L 69/00; C08F 259/08; C08F 279/06; C08K 3/042; C08K 3/34; C08K 5/52; C08K 9/06; C08K 2201/001; C08K 2201/003; C08K 2201/011; C08L 2201/02; C08L 2203/30; C08L 2205/03

(57) ABSTRACT

A thermoplastic resin composition of the present invention is characterized by comprising: about 100 parts by weight of a polycarbonate resin; about 1 to about 15 parts by weight of a rubber-modified vinyl-based copolymer resin; about 10 to about 30 parts by weight of a phosphorus-based flame retardant; about 0.01 to about 0.5 parts by weight of a fluoropolymer encapsulated with methyl methacrylate; about 1 to about 20 parts by weight of wollastonite; about 2 to about 8 parts by weight of graphene composed of 1 to 3 carbon atom layers and having an average particle diameter (D50) of about 5 to about 15 nm; and about 0.5 to about 5 parts by weight of carbon black coated with silicon (Si). The thermoplastic resin composition has excellent electrical conductivity, flame retardancy, fluidity, impact resistance, balance of physical properties thereof, and the like.

### TECHNICAL FIELD

The present invention relates to a thermoplastic resin composition and a molded article produced therefrom. More particularly, the present invention relates to a thermoplastic resin composition that exhibits good properties in terms of electrical conductivity, flame retardancy, fluidity, impact resistance, and balance therebetween, and the like, and a molded article produced therefrom.

### BACKGROUND ART

Polycarbonate resins have good processability and moldability to be widely applied to various household goods, office automation equipment, electrical/electronic products, and the like. In addition, various attempts have been made to apply polycarbonate resins to automobiles, electrical devices, home appliances, such as televisions and the like, electronic assemblies, cables, and the like by imparting electrical conductivity and electromagnetic wave-shielding performance thereto.

As a method for imparting electrical conductivity to a thermoplastic resin composition comprising a polycarbonate resin and the like, conductive fillers, such as carbon black, carbon fibers, carbon nanotubes, metal powder, metal-coated inorganic powder, metal fibers, and the like, may be mixed therewith.

However, a large amount of conductive filler is required to realize desired electrical conductivity of the thermoplastic resin composition, causing deterioration in mechanical properties (such as impact resistance and the like), flame retardancy, external appearance, and the like of the thermoplastic resin composition and products thereof through deterioration in fluidity, compatibility, and the like.

Therefore, there is a need for development of a thermoplastic resin composition that has good properties in terms of electrical conductivity, flame retardancy, fluidity, impact resistance, balance therebetween and the like even when conductive fillers are applied thereto.

The background technique of the present invention is disclosed in Korean Patent Laid-open Publication No. 10-2012-0078342 and the like.

### Disclosure

### Technical Problem

It is one aspect of the present invention to provide a thermoplastic resin composition that exhibits good properties in terms of electrical conductivity, flame retardancy, fluidity, impact resistance, and balance therebetween.

It is another aspect of the present invention to provide a molded article formed of the thermoplastic resin composition.

The above and other aspects of the present invention can be achieved by the present invention described below.

### Technical Solution

1. One aspect of the present invention relates to a thermoplastic resin composition. The thermoplastic resin composition may include: about 100 parts by weight of a polycarbonate resin; about 1 part by weight to about 15 parts by weight of a rubber-modified vinyl copolymer resin; about 10 parts by weight to about 30 parts by weight of a phosphorus flame retardant; about 0.01 parts by weight to about 0.5 parts by weight of a fluoropolymer encapsulated with methyl methacrylate; about 1 part by weight to about 20 parts by weight of wollastonite; about 2 parts by weight to about 8 parts by weight of graphene composed of 1 to 3 carbon atom layers and having an average particle diameter of about 5 nm to about 15 nm; and about 0.5 parts by weight to about 5 parts by weight of carbon black coated with silicon (Si).

2. In embodiment 1, the rubber-modified vinyl copolymer resin may comprise a rubber-modified aromatic vinyl graft copolymer obtained through graft copolymerization of an alkyl (meth)acrylate monomer and an aromatic vinyl monomer to a rubber polymer.

3. In embodiments 1 or 2, the phosphorus flame retardant may comprise at least one of a phosphate compound, a phosphonate compound, a phosphinate compound, a phosphine oxide compound, and a phosphazene compound.

4. In embodiments 1 to 3, the fluoropolymer encapsulated with methyl methacrylate may comprise about 30 wt % to about 70 wt % of a fluoropolymer and about 30 wt % to about 70 wt % of methyl methacrylate.

5. In embodiments 1 to 4, the wollastonite may have a cross-sectional diameter of about 5 μm to about 20 μm and a post-processing length of about 50 μm to about 200 μm.

6. In embodiments 1 to 5, the graphene and the carbon black coated with silicon may be present in a weight ratio of about 1:0.1 to about 1:1 (graphene:carbon black coated with silicon).

7. In embodiments 1 to 6, the thermoplastic composition may have a surface resistance of about 1×10³ Ω/sq to about 9×10³ Ω/sq, as measured on a 3.2 mm thick specimen using a surface resistance meter in accordance with ASTM D257.

8. In embodiments 1 to 7, the thermoplastic composition may have a flame retardancy of V-1 or higher, as measured on a 1.5 mm thick specimen by the UL-94 vertical test method.

9. In embodiments 1 to 8, the thermoplastic composition may have a melt-flow index (MI) of about 30 g/10 min to about 45 g/10 min, as measured at 220° C. under a load of 10 kgf in accordance with ASTM D1238.

10. In embodiments 1 to 9, the thermoplastic composition may have a spiral flow length of about 40 cm to about 50 cm, as measured on a specimen prepared through injection molding in a spiral-shaped mold having a width of 15 mm and a thickness of 2 mm under conditions of a molding temperature of 260° C., a mold temperature of 60° C., an injection pressure of 1,000 kgf/cm², and an injection rate of 60 mm/s.

11. In embodiments 1 to 10, the thermoplastic composition may have a notched Izod impact strength of about 3 kgf cm/cm to about 10 kgf cm/cm, as measured on a ⅛″ thick specimen in accordance with ASTM D256.

12. Another aspect of the present invention relates to a molded article. The molded article is formed of the thermoplastic resin composition according to any one of embodiments 1 to 11.

### Advantageous Effects

The present invention provides a thermoplastic resin composition that has good properties in terms of electrical conductivity, flame retardancy, fluidity, impact resistance, and balance therebetween, and the like, and a molded article produced therefrom.

### BEST MODE

Hereinafter, embodiments of the present invention will be described in detail.

A thermoplastic resin composition according to the present invention includes: (A) a polycarbonate resin; (B) a rubber-modified vinyl copolymer resin; (C) a phosphorus flame retardant; (D) a fluoropolymer encapsulated with methyl methacrylate; (E) wollastonite; (F) graphene; and (G) carbon black coated with silicon.

As used herein to represent a numerical range, “a to b” is defined as “≥a and ≤b”.

### (A) Polycarbonate Resin

The polycarbonate resin according to one embodiment of the present invention may include any polycarbonate resin used in typical thermoplastic resin compositions. For example, the polycarbonate resin may be an aromatic polycarbonate resin prepared by reacting diphenols (aromatic diol compounds) with a carbonate precursor, such as phosgene, halogen formate, and carbonate diester.

In some embodiments, the diphenols may include, for example, 4,4′-biphenol, 2,2-bis(4-hydroxyphenyl) propane, 2,4-bis(4-hydroxyphenyl)-2-methylbutane, 1,1-bis(4-hydroxyphenyl)cyclohexane, 2,2-bis(3-chloro-4-hydroxyphenyl) propane, 2,2-bis-(3,5-dichloro-4-hydroxyphenyl) propane, 2,2-bis(3-methyl-4-hydroxyphenyl) propane, 2,2-bis(3,5-dimethyl-4-hydroxyphenyl) propane, and the like, without being limited thereto. For example, the diphenol may be 2,2-bis(4-hydroxyphenyl) propane, 2,2-bis(3,5-dichloro-4-hydroxyphenyl) propane, 2,2-bis(3-methyl-4-hydroxyphenyl) propane, 2,2-bis(3,5-dimethyl-4-hydroxyphenyl) propane, or 1,1-bis(4-hydroxyphenyl)cyclohexane, specifically 2,2-bis(4-hydroxyphenyl) propane, which is also referred to as bisphenol-A.

In some embodiments, the carbonate precursors may include dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, carbonyl chloride (phosgene), diphosgene, triphosgene, carbonyl bromide, bishaloformate, and the like. These may be used alone or as mixtures thereof.

In some embodiments, the polycarbonate resin may be a branched polycarbonate resin. For example, the polycarbonate resin may be a polycarbonate resin prepared by adding a tri- or higher polyfunctional compound, specifically, a tri- or higher valent phenol group-containing compound, in an amount of about 0.05 mol % to about 2 mol % based on the total number of moles of the diphenols used in polymerization.

In some embodiments, the polycarbonate resin may be a homopolycarbonate resin, a copolycarbonate resin, or a blend thereof. In addition, the polycarbonate resin may be partly or completely replaced by an aromatic polyester-carbonate resin obtained by polymerization in the presence of an ester precursor, for example, a bifunctional carboxylic acid.

In some embodiments, the polycarbonate resin may have a weight average molecular weight (Mw) of about 15,000 g/mol to about 60,000 g/mol, for example, about 20,000 g/mol to about 40,000 g/mol, as measured by gel permeation chromatography (GPC). Within this range, the thermoplastic resin composition can have good impact resistance, fluidity, and the like.

In some embodiments, the polycarbonate resin may have a melt-flow index (MI) of about 3 g/10 min to about 80 g/10 min, as measured at 300° C. under a load of 1.2 kgf in accordance with ISO 1133. The polycarbonate resin may also be a mixture of two or more polycarbonate resins having different melt-flow indices.

### (B) Rubber-Modified Vinyl Copolymer Resin

The rubber-modified vinyl copolymer resin according to one embodiment of the present invention is applied to the polycarbonate resin together with the phosphorus flame retardant, the fluoropolymer encapsulated with methyl methacrylate, wollastonite, graphene, and carbon black coated with silicon to improve electrical conductivity, flame retardancy, fluidity, impact resistance, balance therebetween, and the like of the thermoplastic resin composition, and may be realized by a rubber-modified aromatic vinyl graft copolymer (B1) obtained through graft copolymerization of an alkyl (meth)acrylate monomer and an aromatic vinyl monomer to a rubber polymer, or by a mixture of the rubber-modified aromatic vinyl graft copolymer (B1) and an aromatic vinyl copolymer resin (B2).

Herein, unless specifically stated otherwise, “(meth)acryl” means both “acryl” and “methacryl”. For example, “(meth)acrylate” means both “acrylate” and “methacrylate”.

### (B1) Rubber-Modified Aromatic Vinyl Graft Copolymer

The rubber-modified aromatic vinyl graft copolymer according to one embodiment of the invention may be prepared by adding an alkyl (meth)acrylate, an aromatic vinyl monomer, and, optionally, a monomer for imparting processability and heat resistance, as needed, to a rubber polymer, followed by polymerization (graft polymerization). Here, polymerization may be performed by any suitable polymerization method known in the art, such as emulsion polymerization, suspension polymerization, bulk polymerization, and the like.

In some embodiments, the rubber polymer may include, for example, diene rubbers, such as polybutadiene, poly(styrene-butadiene), poly(acrylonitrile-butadiene), and the like, saturated rubbers obtained by adding hydrogen to the diene rubbers, isoprene rubbers, acrylic rubbers, such as poly(butyl acrylate) and the like, ethylene-propylene-diene terpolymer (EPDM), and the like. These may be used alone or as a mixture thereof. For example, the rubber polymer may comprise diene rubbers, specifically a butadiene rubber. The rubber polymer may be present in an amount of about 20 wt % to about 70 wt %, for example, about 30 wt % to about 65 wt %, based on the total weight (100 wt %) of the rubber-modified aromatic vinyl graft copolymer. Within this range, the thermoplastic resin composition can have good properties in terms of impact resistance, mechanical properties, and the like.

In some embodiments, the rubber polymer (rubber particles) may have an average particle diameter of about 0.05 μm to about 6 μm, for example, about 0.15 μm to about 4 μm, specifically about 0.25 μm to about 3.5 μm. Within this range, the thermoplastic resin composition can have good properties in terms of impact resistance, external appearance, and the like. Here, the average (z-average) particle diameter of the rubber polymer (rubber particles) may be measured by a light scattering method in a latex state. Specifically, a rubber polymer latex is filtered through a mesh to remove coagulum generated during polymerization of the rubber polymer, followed by placing a mixed solution of 0.5 g of the latex and 30 ml of distilled water in a 1,000 ml flask, which in turn is filled with distilled water to prepare a specimen. Then, 10 ml of the specimen is transferred to a quartz cell, followed by measurement of the average particle diameter of the rubber polymer using a light scattering particle analyzer (Nano-zs, Malvern Co., Ltd.).

In some embodiments, the alkyl (meth)acrylate monomer may include methyl (meth)acrylate, ethyl (meth)acrylate, propyl (meth)acrylate, and the like. These may be used alone or as a mixture thereof. For example, the alkyl (meth)acrylate monomer may include methyl (meth)acrylate, specifically methyl methacrylate. The alkyl (meth)acrylate monomer may be present in an amount of about 1 wt % to about 35 wt %, for example, about 5 wt % to about 30 wt %, based on the total weight of the rubber-modified aromatic vinyl graft copolymer. Within this range, the thermoplastic resin composition can have good properties in terms of impact resistance, mechanical properties, and the like.

In some embodiments, the aromatic vinyl monomer may be graft copolymerizable with the rubber polymer and may include, for example, styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, without being limited thereto. These may be used alone or as a mixture thereof. The aromatic vinyl monomer may be present in an amount of about 5 wt % to about 40 wt %, for example, about 10 wt % to about 30 wt %, based on the total weight (100 wt %) of the rubber-modified aromatic vinyl graft copolymer. Within this range, the thermoplastic resin composition can have good properties in terms of impact resistance, mechanical properties, and the like.

In some embodiments, the monomer for imparting processability and heat resistance may include, for example, vinyl cyanide compounds, such as acrylonitrile, methacrylonitrile, ethacrylonitrile, phenyl acrylonitrile, α-chloroacrylonitrile, fumaronitrile, and the like, acrylic acid, maleic anhydride, N-substituted maleimide, and the like, without being limited thereto. These may be used alone or as a mixture thereof. The monomer for imparting processability and heat resistance may be present in an amount of about 15 wt % or less, for example, about 0.1 wt % to about 10 wt %, based on the total weight of the rubber-modified aromatic vinyl graft copolymer. Within this range, the monomer for imparting processability and heat resistance can further improve processability, heat resistance, mechanical properties and the like of the thermoplastic resin composition without deterioration in other properties.

In some embodiments, the rubber-modified aromatic vinyl graft copolymer may include, for example, a graft copolymer (g-MBS) in which methyl methacrylate and a styrene monomer as an aromatic vinyl compound are grafted to a butadiene rubber polymer, a grafted copolymer (g-MBS) in which a styrene monomer, an acrylonitrile monomer, and methyl methacrylate are grafted to a butadiene rubber polymer, and the like.

In some embodiments, the rubber-modified aromatic vinyl graft copolymer may be present in an amount of about 60 wt % or more, for example, about 80 wt % to about 100 wt %, based on 100 wt % of the rubber-modified vinyl copolymer resin. Within this range, the thermoplastic resin composition can have good properties in terms of impact resistance, mechanical properties, fluidity, and the like.

### (B2) Aromatic Vinyl Copolymer Resin

The aromatic vinyl copolymer resin according to one embodiment of the present invention may be an aromatic vinyl copolymer resin used in typical rubber-modified vinyl copolymer resins. For example, the aromatic vinyl copolymer resin may be a polymer of a monomer mixture comprising an aromatic vinyl monomer and a monomer, such as a vinyl cyanide monomer and the like, which is copolymerizable with the aromatic vinyl monomer.

In some embodiments, the aromatic vinyl copolymer resin may be obtained by mixing the aromatic vinyl monomer and the monomer copolymerizable with the aromatic vinyl monomer, followed by polymerization. Here, polymerization may be performed by any typical polymerization methods known to those skilled in the art, such as emulsion polymerization, suspension polymerization, bulk polymerization, and the like.

In some embodiments, the aromatic vinyl monomer may include, for example, styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, without being limited thereto. These may be used alone or as a mixture thereof. The aromatic vinyl monomer may be present in an amount of about 20 wt % to about 90 wt %, for example, about 30 wt % to about 80 wt %, based on 100 wt % of the aromatic vinyl copolymer resin. Within this range, the thermoplastic resin composition can have good properties in terms of impact resistance, fluidity, and the like.

In some embodiments, the monomer copolymerizable with the aromatic vinyl monomer may include a vinyl cyanide monomer, for example, acrylonitrile, methacrylonitrile, ethacrylonitrile, phenyl acrylonitrile, α-chloroacrylonitrile, fumaronitrile, and the like. These may be used alone or as a mixture thereof. The monomer copolymerizable with the aromatic vinyl monomer may be present in an amount of about 10 wt % to about 80 wt %, for example, about 20 wt % to about 70 wt %, based on 100 wt % of the aromatic vinyl copolymer resin. Within this range, the thermoplastic resin composition can have good properties in terms of impact resistance, fluidity, and the like.

In some embodiments, the aromatic vinyl copolymer resin may have a weight average molecular weight (Mw) of about 10,000 g/mol to about 300,000 g/mol, for example, about 15,000 g/mol to about 150,000 g/mol, as measured by GPC (gel permeation chromatography). Within this range, the thermoplastic resin composition can have good properties in terms of mechanical strength, moldability, and the like.

In some embodiments, the aromatic vinyl copolymer resin may be present in an amount of about 20 wt % or less, for example, about 10 wt % or less, based on 100 wt % of the rubber-modified vinyl copolymer resin. Within this range, the thermoplastic resin composition can exhibit good properties in terms of fluidity, thermal stability, and the like.

In some embodiments, the rubber-modified vinyl copolymer resin may be present in an amount of about 1 part by weight to about 15 parts by weight, for example, about 4 parts by weight to about 12 parts by weight, relative to about 100 parts by weight of the polycarbonate resin. If the content of the rubber-modified vinyl copolymer resin is less than about 1 part by weight relative to about 100 parts by weight of the polycarbonate resin, the thermoplastic resin composition can suffer from deterioration in fluidity, impact resistance, and the like, and if the content of the rubber-modified vinyl copolymer resin exceeds about 15 parts by weight, the thermoplastic resin composition can suffer from deterioration in flame retardancy, fluidity, and the like.

### (C) Phosphorus Flame Retardant

The phosphorus flame retardant according to one embodiment of the invention is applied to the polycarbonate resin together with the rubber-modified vinyl copolymer resin, the fluoropolymer encapsulated with methyl methacrylate, wollastonite, graphene, and carbon black coated with silicon to improve electrical conductivity, flame retardancy, fluidity, impact resistance, balance therebetween, and the like of the thermoplastic resin composition and may include a phosphorus flame retardant used in typical thermoplastic resin compositions. For example, the phosphorus flame retardant may include a phosphate compound, a phosphonate compound, a phosphinate compound, a phosphine oxide compound, a phosphazene compound, and a metal salt thereof. These may be used alone or as a mixture thereof.

In some embodiments, the phosphorus flame retardant may include an aromatic phosphoric ester compound represented by Formula 1.

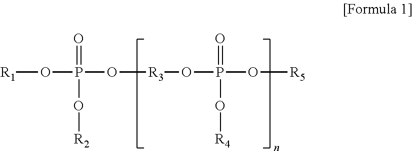

where R₁, R₂, R₄, and R₅ are each independently a hydrogen atom, a C₆ to C₂₀ (carbon number: 6 to 20) aryl group, or a C₁ to C₁₀ alkyl group-substituted C₆ to C₂₀ aryl group; R₃ is a C₆ to C₂₀ arylene group or a C₁ to C₁₀ alkyl group-substituted C₆ to C₂₀ arylene group, for example, derivatives of a dialcohol, such as resorcinol, hydroquinone, bisphenol-A, or bisphenol-S; and n is an integer of 0 to 10, for example, 0 to 4.

When n is 0 in Formula 1, examples of the aromatic phosphoric ester compound may include diaryl phosphates, such as diphenyl phosphate and the like, triphenyl phosphate, tricresyl phosphate, trixylenyl phosphate, tri(2,6-dimethylphenyl) phosphate, tri(2,4,6-trimethylphenyl) phosphate, tri(2,4-di-tert-butylphenyl) phosphate, and tri(2,6-dimethylphenyl) phosphate; and when n is 1 in Formula 1, examples of the aromatic phosphoric ester compound may include bisphenol-A bis(diphenyl phosphate), resorcinol bis(diphenyl phosphate), resorcinol bis[bis(2,6-dimethylphenyl) phosphate], resorcinol bis[bis(2,4-di-tert-butylphenyl) phosphate], hydroquinone bis[bis(2,6-dimethylphenyl) phosphate], hydroquinone bis(diphenyl phosphate), and hydroquinone bis[bis(2,4-di-tert-butylphenyl) phosphate], without being limited thereto. These compounds may be used alone or as a mixture thereof.

In some embodiments, the phosphorus flame retardant may be present in an amount of about 10 parts by weight to about 30 parts by weight, for example, about 12 parts by weight to about 25 parts by weight, specifically about 18 parts by weight to about 22 parts by weight, relative to about 100 parts by weight of the polycarbonate resin. Within this range, the thermoplastic resin composition can have good properties in terms of flame retardancy, heat resistance, fluidity, and the like. If the content of the phosphorus phosphide flame retardant is less than about 10 parts by weight relative to about 100 parts by weight of the polycarbonate resin, the thermoplastic resin composition can suffer from deterioration in flame retardancy, fluidity, and the like, and if the content of the phosphorus phosphide flame retardant exceeds about 30 parts by weight, the thermoplastic resin composition can suffer from deterioration in fluidity, impact resistance, and the like.

(D) Fluoropolymer Capsulated with Methyl Methacrylate

The fluoropolymer encapsulated with methyl methacrylate according to one embodiment of the present invention is applied to the polycarbonate resin together with the rubber-modified vinyl copolymer resin, the phosphorus flame retardant, wollastonite, graphene, and carbon black coated with silicon to improve electrical conductivity, flame retardancy, fluidity, impact resistance, balance therebetween, and the like of the thermoplastic resin compositions, and may be prepared by encapsulating a fluoropolymer, such as polytetrafluoroethylene (PTFE), which is typically used for a typical flame retardant, with methyl methacrylate (MMA).

In some embodiments, the fluoropolymer encapsulated with methyl methacrylate may comprise about 30 wt % to about 70 wt %, for example, about 40 wt % to about 60 wt %, of the fluoropolymer and about 30 wt % to about 70 wt %, for example, about 40 wt % to about 60 wt %, of methyl methacrylate. Within this range, the thermoplastic resin composition can have good flame retardancy and the like.

In some embodiments, the fluoropolymer encapsulated with methyl methacrylate may be present in an amount of about 0.01 parts by weight to about 0.5 parts by weight, for example, about 0.05 parts by weight to about 0.4 parts by weight, relative to about 100 parts by weight of the polycarbonate resin. If the content of the fluoropolymer encapsulated with methyl methacrylate is less than about 0.01 parts by weight relative to about 100 parts by weight of the polycarbonate resin, the thermoplastic resin composition can suffer from deterioration in flame retardancy and the like, and if the content of the fluoropolymer encapsulated with methyl methacrylate exceeds about 0.5 parts by weight, the thermoplastic resin composition can suffer from deterioration in fluidity and the like.

In some embodiments, the phosphorus flame retardant (C) and the fluoropolymer encapsulated with methyl methacrylate (D) may be present in a weight ratio (C:D) of about 1:0.001 to about 1:0.03, for example, about 1:0.004 to about 1:0.025. Within this range, the thermoplastic resin composition can have good properties in terms of flame retardancy, fluidity, and the like.

### (E) Wollastonite

The wollastonite according to one embodiment of the present invention is applied to the polycarbonate resin together with the rubber-modified vinyl copolymer resin, the phosphorus flame retardant, the fluoropolymer encapsulated with methyl methacrylate, graphene and carbon black coated with silicon to improve electrical conductivity, flame retardancy, fluidity, impact resistance, balance therebetween, and the like of the thermoplastic resin compositions, and may be selected from typical acicular wollastonite.

In some embodiments, the wollastonite is a white acicular calcium-based mineral and may be subjected to hydrophobic surface treatment on at least part of a surface thereof. Here, hydrophobic surface treatment may include, for example, coating wollastonite with an olefin, epoxy or silane material, without being limited thereto.

In some embodiments, the wollastonite may have a cross-section diameter of about 5 μm to about 20 μm, for example, about 8 μm to about 15 μm, a pre-processing length of about 10 mm to about 500 mm, and a post-processing length of about 50 μm to about 200 μm, for example, about 100 μm to about 150 μm, as measured using a particle analyzer (Malvern Mastersizer 300). Within this range, the thermoplastic resin composition can exhibit good properties in terms of dimensional stability, impact resistance, and the like.

In some embodiments, the wollastonite may be present in an amount of about 1 part by weight to about 20 parts by weight, for example, about 5 parts by weight to about 18 parts by weight, specifically about 9 parts by weight to about 15 parts by weight, relative to about 100 parts by weight of the polycarbonate resin. If the content of the wollastonite is less than about 1 part by weight relative to about 100 parts by weight of the polycarbonate resin, the thermoplastic resin composition can suffer from deterioration in electrical conductivity, rigidity, dimensional stability, and the like, and if the content of the wollastonite exceeds about 20 parts by weight, the thermoplastic resin composition can suffer from deterioration in fluidity, impact resistance, and the like.

### (F) Graphene

Graphene according to one embodiment of the present invention is applied to the polycarbonate resin together with the rubber-modified vinyl copolymer resin, the phosphorus flame retardant, the fluoropolymer encapsulated with methyl methacrylate, wollastonite, and carbon black coated with silicon to improve electrical conductivity, flame retardancy, fluidity, impact resistance, and balance therebetween, and the like of the thermoplastic resin composition, and may include graphene composed of 1 to 3 carbon atom layers and having an average particle diameter (D50) of about 5 nm to about 15 nm.

Typically, graphene refers to a two-dimensional thin film with a honeycomb structure composed of a single layer or multiple layers of carbon (C) atoms. When carbon atoms are bonded to each other through sp2 hybridization, the carbon atoms form a honeycomb-shaped carbon network. Carbon has four outermost electrons, which participate in carbon bonding through hybridization. A carbon-carbon bond is realized by two methods: sp3 bonding and sp2 bonding, in which a material composed only of sp3 bonds includes square diamond and a material composed only of sp2 bonds includes graphite or graphene, which is a layer of graphite. For example, electrons originally supposed to exist only in s and p orbitals have sp2 and sp3 hybrid orbitals that combine s and p orbitals. Since the sp2 hybrid orbital has a single electron in the s orbital and two electrons in the p orbital, the sp2 hybrid orbital has a total of three electrons each having the same energy level. Since it is more stable to have a hybrid orbital than to have the s and p orbitals separately, the electrons are in a hybrid orbital state. An aggregate of carbon atoms having a planar structure due to such sp2 bonds is graphene, a single layer of which has a thickness of about 0.3 nm corresponding to the size of a single carbon atom. Graphene has metallic properties, exhibits electrical conductivity in a layer direction, has good thermal conductivity and high mobility of charge carriers, which makes it possible to realize high-speed electronic devices. It is known that a graphene sheet has an electron mobility of about 20,000 cm²/Vs to about 50,000 cm²/Vs.

In some embodiments, the graphene may be composed 1 to 3 carbon atoms layers. When the number of carbon atom layers of the graphene exceeds 3 layers, the thermoplastic resin composition can suffer from deterioration in electrical conductivity and the like.

In some embodiments, the graphene may have an average particle diameter (D50) of about 5 nm to about 15 nm, for example, about 7 nm to about 12 nm. If the average particle diameter (D50) of the graphene is less than about 5 nm, the thermoplastic composition can suffer from deterioration in fluidity, impact resistance, and the like, and if the average particle diameter (D50) of the graphene exceeds about 15 nm, the thermoplastic composition can suffer from deterioration in electrical conductivity and the like. Here, “average particle diameter (D50)” means a typical particle diameter known to those skilled in the art and may mean a particle diameter corresponding to 50 vol % (% by volume) of the particles when the particles are distributed in order from smallest to largest by volume.

In some embodiments, the graphene may be present in an amount of about 2 parts by weight to about 8 parts by weight, for example, about 3 parts by weight to about 7 parts by weight, specifically about 4 parts by weight to about 6 parts by weight, relative to about 100 parts by weight of the polycarbonate resin. If the content of the graphene is less than about 2 parts by weight relative to about 100 parts by weight of the polycarbonate resin, the thermoplastic resin composition can suffer from deterioration in electrical conductivity and the like, and if the content of the graphene exceeds about 8 parts by weight, the thermoplastic resin composition can suffer from deterioration in flame retardancy, fluidity, impact resistance, and the like.

(G) Carbon Black Coated with Silicon (Si)

The carbon black coated with silicon (Si) according to one embodiment of the present invention is applied to the polycarbonate resin together with the rubber-modified vinyl copolymer resin, the phosphorus flame retardant, the fluoropolymer encapsulated with methyl methacrylate, wollastonite, and graphene to improve electrical conductivity, flame retardancy, fluidity, impact resistance, balance therebetween, and the like of the thermoplastic resin composition.

In some embodiments, the carbon black coated with silicon may have an average particle diameter (D50) of about 5 nm to about 150 nm, for example, about 10 nm to about 100 nm.

In some embodiments, the carbon black coated with silicon may be present in an amount of about 0.5 parts by weight to about 5 parts by weight, for example, about 1 part by weight to about 3 parts by weight, relative to about 100 parts by weight of the polycarbonate resin. If the content of the carbon black coated with silicon is less than about 0.5 parts by weight relative to about 100 parts by weight of the polycarbonate resin, the thermoplastic resin composition can suffer from deterioration in electrical conductivity and the like, and if the content of the carbon black coated with silicon exceeds about 5 parts by weight, the thermoplastic resin composition can suffer from deterioration in flame retardancy and the like.

In some embodiments, the graphene (F) and the carbon black coated with silicon (G) may be present in a weight ratio (F:G) of about 1:0.1 to about 1:1, for example, about 1:0.2 to about 1:0.7. Within this range, the thermoplastic resin composition can have better properties in terms of electrical conductivity, impact resistance, and the like.

The thermoplastic resin composition according to one embodiment of the present invention may further include additives used for typical thermoplastic resin compositions. Examples of the additives may include antioxidants, release agents, lubricants, nucleating agents, stabilizers, pigments, dyes, and mixtures thereof. The additives may be present in an amount of about 0.001 parts by weight to about 40 parts by weight, for example, about 0.1 parts by weight to about 10 parts by weight, relative to 100 parts by weight of the polycarbonate resin.

In some embodiments, the thermoplastic resin composition may be prepared in pellet form by mixing the above components, followed by melt extrusion of the mixture at about 220° C. to about 300° C., for example, about 230° C. to about 270° C., using a typical twin-screw extruder.

In some embodiments, the thermoplastic resin composition may have a surface resistance of about 1×10³ Ω/sq to about 9×10³ Ω/sq, for example, about 1×10³ Ω/sq to about 7×10³ Ω/sq, as measured on a 3.2 mm-thick specimen in accordance with ASTM D257.

In some embodiments, the thermoplastic resin composition may have a flame retardancy of V-1 or higher, as measured on a 1.5 mm thick specimen by a UL-94 vertical test method.

In some embodiments, the thermoplastic resin composition may have a melt-flow index (MI) of about 30 g/10 min to about 45 g/10 min, for example, about 31 g/10 min to about 40 g/10 min, as measured at 220° C. under a load of 10 kgf in accordance with ASTM D1238.

In some embodiments, the thermoplastic resin composition may have a spiral flow length of about 40 cm to about 50 cm, for example, about 40 cm to about 45 cm, as measured on a specimen prepared through injection molding in a spiral-shaped mold having a size of 15 mm width and a thickness of 1 mm under conditions of a molding temperature of 260° C., a mold temperature of 60° C., an injection pressure of 1,000 kgf/cm², and an injection rate of 60 mm/s.

In some embodiments, the thermoplastic resin composition may have a notched Izod impact strength of about 3 kgf cm/cm to about 10 kgf cm/cm, for example, about 4 kgf cm/cm to about 7 kgf cm/cm, as measured on a ⅛″ specimen in accordance with ASTM D256.

A molded article according to the present invention is formed of the thermoplastic resin composition as set forth above. For example, the thermoplastic resin composition may be produced into various molded articles (products) through various molding methods, such as injection molding, extrusion molding, vacuum molding, casting, and the like. These molding methods are well known to a person having ordinary knowledge in the art. The molded article has good properties in terms of electrical conductivity, flame retardancy, fluidity, impact resistance, balance therebetween and the like, and thus can be advantageously used for antistatic materials and the like.

### MODE FOR INVENTION

Next, the present invention will be described in more detail with reference to some examples. It should be understood that these examples are provided for illustration only and are not to be construed in any way as limiting the invention.

### Example

Details of components used in Examples and Comparative Examples are as follows.

### (A) Polycarbonate Resin

A bisphenol-A polycarbonate resin (weight average molecular weight (Mw): about 22,000 g/mol) was used.

### (B) Rubber-Modified Vinyl Copolymer Resin

A copolymer (g-MBS) (manufacturer: Dow Chemical, product name: BTA-731) prepared through graft copolymerization of a styrene monomer as an aromatic vinyl compound and methyl methacrylate to a butadiene rubber polymer was used.

### (C) Phosphorus Flame Retardant

An oligomer type bisphenol-A diphosphate (bisphenol-A diphosphate, manufacturer: Yoke Chemical, product name: YOKE BDP) was used.

(D) Fluoropolymer Capsulated with Methyl Methacrylate

Methyl methacrylate-encapsulated polytetrafluoroethylene (MMA-PTFE, manufacturer: Focera, product name: Xflon-ACL) was used.

### (E) Wollastonite

Wollastonite (manufacturer: Hubei, product name: WFC5-4101, cross-sectional diameter: 10 μm, post-processing length: 50 μm to 100 μm) was used.

### (F) Graphene

(F1) Graphene composed of 1 to 3 carbon atom layers (manufacturer: Ilshin, product name: KNG-G2, average particle diameter (D50): 7 to 12 nm) was used.

(F2) Multilayer graphene having more than three layers of carbon atoms (Manufacturer: Ilshin, product name: KNG-T181, average grain diameter (D50): 100 nm) was used.

### (G) Carbon Black

(G1) Carbon black coated with silicon (manufacturer: Cabot, product name: Vulcan XC72) was used.

(G2) Carbon black (manufacturer: Columbian Chemicals, product name: Raven 2900 Ultra Powder) was used.

### Examples 1 to 13 and Comparative Examples 1 to 14

The above components were mixed in amounts as listed in Tables 1, 2, 3, and 4 and subjected to extrusion at a temperature of 250° C., thereby preparing a thermoplastic resin composition in pellet form. Here, extrusion was performed using a twin-screw extruder (L/D=44, diameter: 45 mm) and the prepared pellets were dried at 80° C. for 4 hours or more and injection-molded in a 6 oz. injection molding machine (molding temperature: 260° C., mold temperature: 60° C.), thereby preparing specimens. The prepared specimens were evaluated as to the following properties by the following method, and results are shown in Tables 1, 2, 3, and 4.

### Property Measurement

(1) Surface resistance (unit: 22/sq): Surface resistance was measured on a 3.2 mm-thick specimen using a surface resistance meter (MCP HT450) in accordance with ASTM D257.

(2) Flame retardancy: Flame retardancy was measured on a 1.5 mm-thick specimen by a UL-94 vertical test method.

(3) Melt-flow index (MI) (unit: g/10 min): Melt-flow index was measured at a temperature of 230° C. under a load of 10 kgf in accordance with ASTM D1238.

(4) Spiral flow length (unit: cm): Spiral flow length was measured on a specimen prepared through injection molding in a spiral-shaped mold having a size of 15 mm width and a thickness of 1 mm using an injection machine (LGH 140N, LG) under conditions of a molding temperature of 260° C., a mold temperature of 60° C., an injection pressure of 1,000 kgf/cm², and an injection rate of 60 mm/s.

(5) Notched Izod impact strength (unit: kgf·cm/cm): Notched Izod impact strength was measured on a ⅛″ thick Izod specimen in accordance with ASTM D256.

TABLE 1

| | Example | | | | | | |
|---|---|---|---|---|---|---|---|
| | 1 | 2 | 3 | 4 | 5 | 6 | 7 |
| (A) (parts by weight) | 100 | 100 | 100 | 100 | 100 | 100 | 100 |
| (B) (parts by weight) | 4 | 8 | 12 | 8 | 8 | 8 | 8 |
| (C) (parts by weight) | 20 | 20 | 20 | 18 | 22 | 20 | 20 |
| (D) (parts by weight) | 0.2 | 0.2 | 0.2 | 0.2 | 0.2 | 0.1 | 0.4 |
| (E) (parts by weight) | 12 | 12 | 12 | 12 | 12 | 12 | 12 |
| (F1) (parts by weight) | 5 | 5 | 5 | 5 | 5 | 5 | 5 |
| (F2) (parts by weight) | — | — | — | — | — | — | — |
| (G1) (parts by weight) | 2 | 2 | 2 | 2 | 2 | 2 | 2 |
| (G2) (parts by weight) | — | — | — | — | — | — | — |
| Surface resistance | 2 × 10³ | 3 × 10³ | 5 × 10³ | 3 × 10³ | 3 × 10³ | 3 × 10³ | 3 × 10³ |
| Flame retardancy | V-1 | V-1 | V-1 | V-1 | V-1 | V-1 | V-1 |
| Melt-flow index | 36 | 35 | 33 | 32 | 38 | 36 | 33 |
| Spiral flow length | 44 | 43 | 42 | 40 | 45 | 44 | 41 |
| Notched Izod impact | 4.0 | 5.0 | 7.0 | 6.0 | 4.5 | 5.5 | 4.5 |
| resistance | | | | | | | |

TABLE 2

| | Example | | | | | |
|---|---|---|---|---|---|---|
| | 8 | 9 | 10 | 11 | 12 | 13 |
| (A) (parts by weight) | 100 | 100 | 100 | 100 | 100 | 100 |
| (B) (parts by weight) | 8 | 8 | 8 | 8 | 8 | 8 |
| (C) (parts by weight) | 20 | 20 | 20 | 20 | 20 | 20 |
| (D) (parts by weight) | 0.2 | 0.2 | 0.2 | 0.2 | 0.2 | 0.2 |
| (E) (parts by weight) | 9 | 15 | 12 | 12 | 12 | 12 |
| (F1) (parts by weight) | 5 | 5 | 4 | 6 | 5 | 5 |
| (F2) (parts by weight) | — | — | — | — | — | — |
| (G1) (parts by weight) | 2 | 2 | 2 | 2 | 1 | 3 |
| (G2) (parts by weight) | — | — | — | — | — | — |
| Surface resistance | 4 × 10³ | 4 × 10³ | 7 × 10³ | 1 × 10³ | 5 × 10³ | 2 × 10³ |
| Flame retardancy | V-1 | V-1 | V-1 | V-1 | V-1 | V-1 |
| Melt-flow index | 38 | 34 | 40 | 31 | 36 | 35 |
| Spiral flow length | 45 | 42 | 44 | 42 | 43 | 43 |
| Notched Izod impact | 6.0 | 4.0 | 5.5 | 4.0 | 5.1 | 4.8 |
| resistance | | | | | | |

TABLE 3

| | Comparative Example | | | | | | |
|---|---|---|---|---|---|---|---|
| | 1 | 2 | 3 | 4 | 5 | 6 | 7 |
| (A) (parts by weight) | 100 | 100 | 100 | 100 | 100 | 100 | 100 |
| (B) (parts by weight) | 0.5 | 20 | 8 | 8 | 8 | 8 | 8 |
| (C) (parts by weight) | 20 | 20 | 5 | 35 | 20 | 20 | 20 |
| (D) (parts by weight) | 0.2 | 0.2 | 0.2 | 0.2 | 0.005 | 0.7 | 0.2 |
| (E) (parts by weight) | 12 | 12 | 12 | 12 | 12 | 12 | 0.5 |
| (F1) (parts by weight) | 5 | 5 | 5 | 5 | 5 | 5 | 5 |
| (F2) (parts by weight) | — | — | — | — | — | — | — |
| (G1) (parts by weight) | 2 | 2 | 2 | 2 | 2 | 2 | 2 |
| (G2) (parts by weight) | — | — | — | — | — | — | — |
| Surface resistance | 2 × 10³ | 6 × 10³ | 3 × 10³ | 5 × 10³ | 3 × 10³ | 3 × 10³ | 3 × 10⁴ |
| Flame retardancy | V-1 | Fail | Fail | V-1 | V-2 | V-1 | V-1 |
| Melt-flow index | 39 | 30 | 10 | 48 | 37 | 29 | 43 |
| Spiral flow length | 39 | 30 | 22 | 52 | 44 | 39 | 48 |
| Notched Izod impact | 2.0 | 8.0 | 7.5 | 2.0 | 6.0 | 3.0 | 6.5 |
| resistance | | | | | | | |

TABLE 4

| | Comparative Example | | | | | | |
|---|---|---|---|---|---|---|---|
| | 8 | 9 | 10 | 11 | 12 | 13 | 14 |
| (A) (parts by weight) | 100 | 100 | 100 | 100 | 100 | 100 | 100 |
| (B) (parts by weight) | 8 | 8 | 8 | 8 | 8 | 8 | 8 |
| (C) (parts by weight) | 20 | 20 | 20 | 20 | 20 | 20 | 20 |
| (D) (parts by weight) | 0.2 | 0.2 | 0.2 | 0.2 | 0.2 | 0.2 | 0.2 |
| (E) (parts by weight) | 25 | 12 | 12 | 12 | 12 | 12 | 12 |
| (F1) (parts by weight) | 5 | 1 | 10 | — | 5 | 5 | 5 |
| (F2) (parts by weight) | — | — | — | 5 | — | — | — |
| (G1) (parts by weight) | 2 | 2 | 2 | 2 | 0.1 | 7 | — |
| (G2) (parts by weight) | — | — | — | — | — | — | 2 |
| Surface resistance | 6 × 10³ | 4 × 10⁷ | 1 × 10³ | 3 × 10⁵ | 2 × 10⁵ | 2 × 10³ | 6 × 10⁵ |
| Flame retardancy | V-1 | V-1 | Fail | V-1 | V-1 | Fail | V-1 |
| Melt-flow index | 28 | 46 | 21 | 38 | 37 | 32 | 36 |
| Spiral flow length | 39 | 48 | 38 | 43 | 44 | 40 | 43 |
| Notched Izod impact | 2.0 | 6.5 | 2.5 | 5.0 | 5.5 | 4.0 | 5.0 |
| resistance | | | | | | | |

From the result, it could be seen that the thermoplastic resin compositions according to the present invention had good properties in terms of electrical conductivity (surface resistance), flame retardancy, fluidity (melt flow index, spiral flow length), impact resistance (notched Izod impact strength), and balance therebetween, and the like.

Conversely, it could be seen that the resin composition of Comparative Example 1 prepared using an insufficient amount of the rubber-modified vinyl copolymer resin suffered from deterioration in fluidity, impact resistance, and the like; the resin composition of Comparative Example 2 prepared using an excess of the rubber-modified vinyl copolymer resin suffered from deterioration in flame retardancy, fluidity, and the like; the resin composition of Comparative Example 3 prepared using an insufficient amount of the phosphorus flame retardant suffered from deterioration in flame retardancy, fluidity, and the like; and the resin composition of Comparative Example 4 prepared using an excess of the phosphorus flame retardant suffered from deterioration in fluidity, impact resistance, and the like. It could be seen that the resin composition of Comparative Example 5 prepared using an insufficient amount of the fluoropolymer encapsulated with methyl methacrylate suffered from deterioration in flame retardancy, and the like; the resin composition of Comparative Example 6 prepared using an excess of the fluoropolymer encapsulated with methyl methacrylate suffered from deterioration in fluidity and the like; the resin composition of Comparative Example 7 prepared using an insufficient amount of the wollastonite suffered from deterioration in electrical conductivity and the like; and the resin composition of Comparative Example 8 prepared using an excess of the wollastonite suffered from deterioration in fluidity, impact resistance, and the like. It could be seen that the resin composition of Comparative Example 9 prepared using an insufficient amount of the graphene of the present invention suffered from deterioration in electrical conductivity and the like; the resin composition of Comparative Example 10 prepared using an excess of the graphene of the present invention suffered from deterioration in flame retardancy, fluidity, impact resistance, and the like; and the resin composition of Comparative Example 11 prepared using graphene (F2) instead of the graphene of the present invention suffered from deterioration in electrical conductivity, and the like. In addition, the resin composition of Comparative Example 12 prepared using an insufficient amount of the carbon black coated with silicon suffered from deterioration in electrical conductivity and the like; the resin composition of Comparative Example 13 prepared using an excess of the carbon black coated with silicon suffered from deterioration in flame retardancy and the like; and the resin composition of Comparative Example 14 prepared using ordinary uncoated carbon black (G2) instead of the carbon black coated with silicon of the present invention suffered from deterioration in electrical conductivity and the like.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic resin composition comprising:
about 100 parts by weight of a polycarbonate resin;
about 1 part by weight to about 15 parts by weigh of a rubber-modified vinyl copolymer resin;
about 10 parts by weight to about 30 parts by weight of a phosphorus flame retardant;
about 0.01 parts by weight to about 0.5 parts by weight of a fluoropolymer encapsulated with methyl methacrylate;
about 1 part by weight to about 20 parts by weight of wollastonite;
about 2 parts by weight to about 8 parts by weight of graphene composed of 1 to 3 carbon atom layers and having an average particle diameter of about 5 nm to about 15 nm; and
about 0.5 parts by weight to about 5 parts by weight of carbon black coated with silicon (Si).

2. The thermoplastic resin composition according to claim 1, wherein the rubber-modified vinyl copolymer resin comprises a rubber-modified aromatic vinyl graft copolymer obtained through graft copolymerization of an alkyl (meth)acrylate monomer and an aromatic vinyl monomer to a rubber polymer.

3. The thermoplastic resin composition according to claim 1, wherein the phosphorus flame retardant comprise at least one of a phosphate compound, a phosphonate compound, a phosphinate compound, a phosphine oxide compound, and a phosphazene compound.

4. The thermoplastic resin composition according to claim 1, wherein the fluoropolymer encapsulated with methyl methacrylate comprises about 30 wt % to about 70 wt % of a fluoropolymer and about 30 wt % to about 70 wt % of methyl methacrylate.

5. The thermoplastic resin composition according to claim 1, wherein the wollastonite has a cross-sectional diameter of about 5 μm to about 20 μm and a post-processing length of about 50 μm to about 200 μm.

6. The thermoplastic resin composition according to claim 1, wherein the graphene and the carbon black coated with silicon are present in a weight ratio of about 1:0.1 to about 1:1 (graphene:carbon black coated with silicon).

7. The thermoplastic resin composition according to claim 1, wherein the thermoplastic composition has a surface resistance of about 1×10³Ω/sq to about 9×10³ Ω/sq, as measured on a 3.2 mm thick specimen using a surface resistance meter in accordance with ASTM D257.

8. The thermoplastic resin composition according to claim 1, wherein the thermoplastic composition has a flame retardancy of V-1 or higher, as measured on a 1.5 mm thick specimen by a UL-94 vertical test method.

9. The thermoplastic resin composition according to claim 1, wherein the thermoplastic composition has a melt-flow index (MI) of about 30 g/10 min to about 45 g/10 min, as measured at 220° C. under a load of 10 kgf in accordance with ASTM D1238.

10. The thermoplastic resin composition according to claim 1, wherein the thermoplastic composition has a spiral flow length of about 40 cm to about 50 cm, as measured on a specimen prepared through injection molding in a spiral-shaped mold having a width of 15 mm and a thickness of 2 mm under conditions of a molding temperature of 260° C., a mold temperature of 60° C., an injection pressure of 1,000 Kgf/cm², and an injection rate of 60 mm/s.

11. The thermoplastic resin composition according to claim 1, wherein the thermoplastic composition has a notched Izod impact strength of about 3 kgf cm/cm to about 10 kgf cm/cm, as measured on a ⅛″ thick specimen in accordance with ASTM D256.

12. A molded article formed of the thermoplastic resin composition according to claim 1.
